(19) United States
(12) Patent Application Publication
(10) Pub. No.: US 2004/0210541 A1
(43) Pub. Date: Oct. 21, 2004

(54) User interface for a rules engine and methods therefor

(76) Inventors: Jeremy Epstien, San Francisco, CA (US); Louis Roehrs, Mountain View, CA (US); James Richards, San Jose, CA (US); William Le Clair, San Jose, CA (US); Krishna Venkatraman, Palo Alto, CA (US)

Correspondence Address: Kang S. Lim, 3494 Camino Tassajara Road #436, Danville, CA, 94506, US

(21) Appl. No.: 10/429,230

(22) Filed: May 1, 2003

Related U.S. Application Data
(63) Continuation-in-part of application No. 10/144,537, filed on May 10, 2002.
Application No. 10/144,537 is a continuation of application No. 09/849,616, filed on May 4, 2001, now Pat. No. 6,553,352.
(63) Continuation-in-part of application No. 09/849,448, filed on May 4, 2001.

(51) Int. Cl. G06F 17/00

(52) U.S. Cl. 705/400

(57) ABSTRACT

The present invention provides an efficient and user friendly rules user interface with screen shots that can prompt and guide a relatively inexperienced user through the process of defining and inputting valid rules and rule attributes into a price optimization system. In one embodiment, the valid rules and associated rule attributes are stored in a composite map of the rules user interface. The screen shots present choices of valid rules and rule attributes in the form of pull down menus. Upon the selection of a rule type from a predetermined menu of valid rule types stored in a composite map, the user interface presents a set of at least one rule attribute from the composite map which is consistent with the selected rule type. State machines assure that only valid transitions are made for a given set of rule attributes and also automatically readjust the rule attribute choices displayed on screenshots of the user interface if a previous attribute or state becomes invalid due the selection of another attribute.

This application is a continuation-in-part of and claims the benefit of a commonly assigned U.S. patent application Ser. No. 10/144,537, filed May 10, 2002, entitled “Interface for Merchandise Price Optimization,” by inventors Michael Neal and Phil Delurgio, herein incorporated by reference, which is a continuation application and claims priority of a commonly assigned U.S. patent application Ser. No. 09/849,616, filed May 4, 2001, issued as U.S. Pat. No. 6,553,352 on Apr. 22, 2003, entitled “Interface for Merchandise Price Optimization,” by inventors Michael Neal and Phil Delurgio. Accordingly, this application also claims the benefit of a commonly assigned U.S. patent application Ser. No. 09/849,616, filed May 4, 2001, issued as U.S. Pat. No. 6,553,352 on Apr. 22, 2003, entitled “Interface for Merchandise Price Optimization,” by inventors Michael Neal and Phil Delurgio.

This application is also a continuation-in-part of and claims the benefit of a commonly assigned U.S. patent application Ser. No. 09/849,448, filed May 4, 2001, entitled “Interface for Merchandise Promotion Optimization,” by inventors Michael Neal and Phil Delurgio, herein incorporated by reference.

### BACKGROUND OF THE INVENTION

The present invention relates in general to price optimization systems. More particularly, the present invention relates to a user interface for a rules engine useful in association with price optimization systems.

An interface for a price optimization system has been disclosed in the above mentioned U.S. patent application Ser. No. 10/144,537 and includes a user interface for a rules engine. For example, FIGS. 34-38 shows a series of screen shots enabling a user to input rules into the rules engine.

However the user interface is a streamlined interface intended for use by a systems analyst who has familiarity and experience with the rules engine and prior knowledge of the structure of valid rules and associated rule attributes. An inexperienced user may attempt to input several invalid rules before finally defining a valid rule.

Hence, improvements can be achieved in the way rules and rule attributes are efficiently inputted by a less experienced user into the rules engine of the price optimization system in a more user friendly and less error prone way.

In view of the foregoing, there is desired an efficient and user friendly interface which can prompt and guide a relatively inexperienced user through the process of defining and inputting rules and rule attributes into a price optimization system.

### SUMMARY OF THE INVENTION

These and other features of the present invention will be described in more detail below in the detailed description of the invention and in conjunction with the following figures.

The present invention provides an efficient and user friendly rules user interface with screen shots that can prompt and guide a relatively inexperienced user through the process of defining and inputting valid rules and rule attributes into a price optimization system.

In one embodiment, the valid rules and associated rule attributes are stored in a composite map of the rules user interface. The screen shots present choices of valid rules and rule attributes in the form of pull down menus.

The user selects a rule from a predetermined menu of valid rule types which are stored in a composite map. Upon the selection of a rule type, the user interface presents a set of at least one rule attribute from the composite map which is consistent with the selected rule type.

State machines assure that only valid transitions are made for a given set of rule attributes and also automatically readjust the rule attribute choices displayed on screenshots of the user interface if a previous attribute or state becomes invalid due the selection of another attribute.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a price optimization system of the present invention.

FIG. 2 illustrates a simplified functional diagram of a rule user interface for the price optimization system of FIG. 1.

FIG. 3 is a flow diagram illustrating the construction of rules and associated rule attributes for the price optimization system.

FIG. 4A is a screen shot illustrating a choice of rule types such as a competitive rule.

FIG. 4B illustrates an exemplary set of screen shots for defining a new competitive rule.

FIGS. 4C, 4D, 5A-5C and 6A-6C are exemplary screen shots illustrating the construction of the new competitive rule.

FIG. 7 illustrates state transitions for the construction of the new competitive rule.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

In accordance with one embodiment of the present invention, a rule user interface is advantageously employed to facilitate a user to define valid business rules for a price optimization system. That is, providing the user with a menu of valid rules and associated rule attributes, and allowing the user to efficiently define and input valid rules into a rules engine for the price optimization system. Business rules unable the user to define the relationships between products and stores.

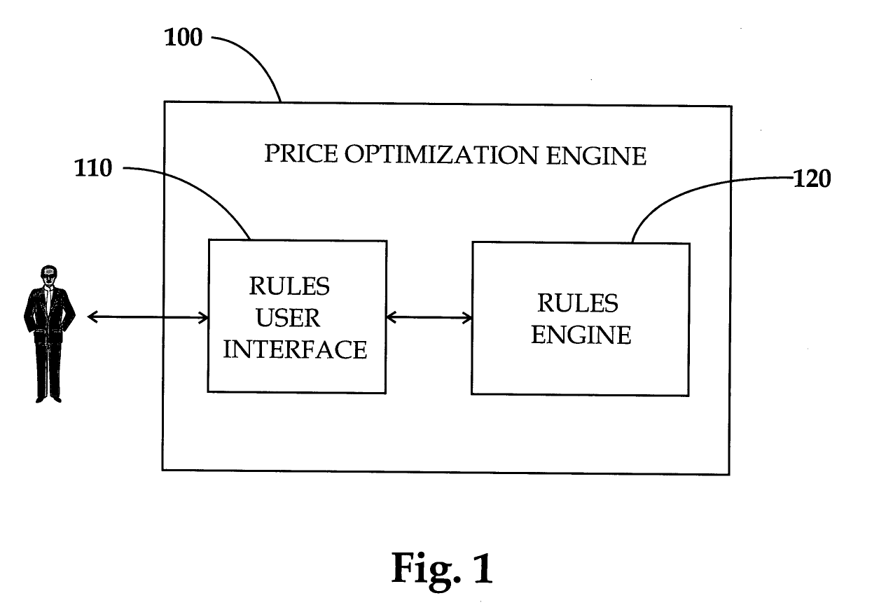

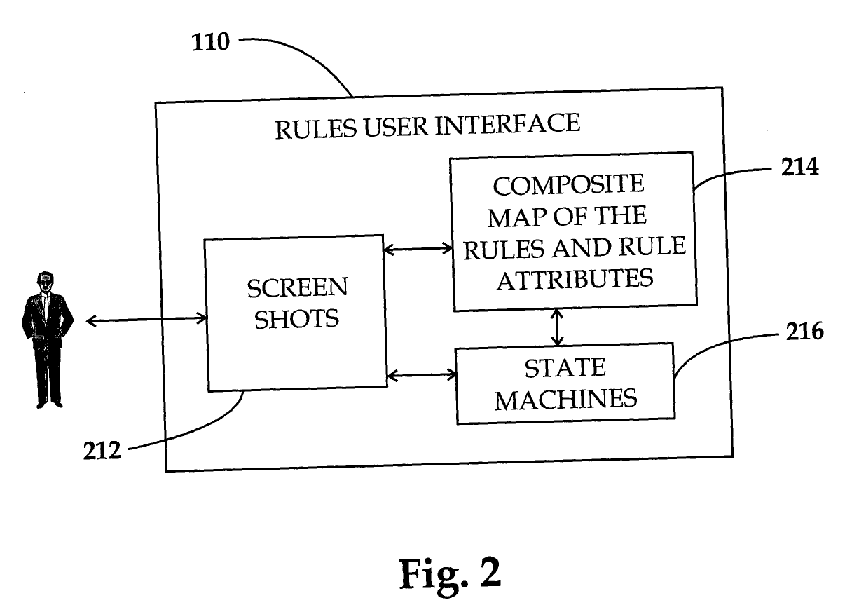

FIG. 1 is a block diagram of a price optimization system 100 which includes a rules engine 120 and a rule user interface 110 of the present invention. Referring now to FIG. 2, a simplified functional diagram of rule user interface 110 is illustrated. Rules user interface 110 comprises a set of screenshots 212 which are templates for displaying a menu of rules and associated rule attributes to a user, a composite map 214 of valid rules and associated rule attributes, and state machines 216 associated with the rule attributes. State machines 216 assure that only valid transitions are made for a given set of rule attributes and also automatically readjust the rule attribute choices displayed on screenshots 212 if a previous attribute or state becomes invalid due the selection of another attribute.

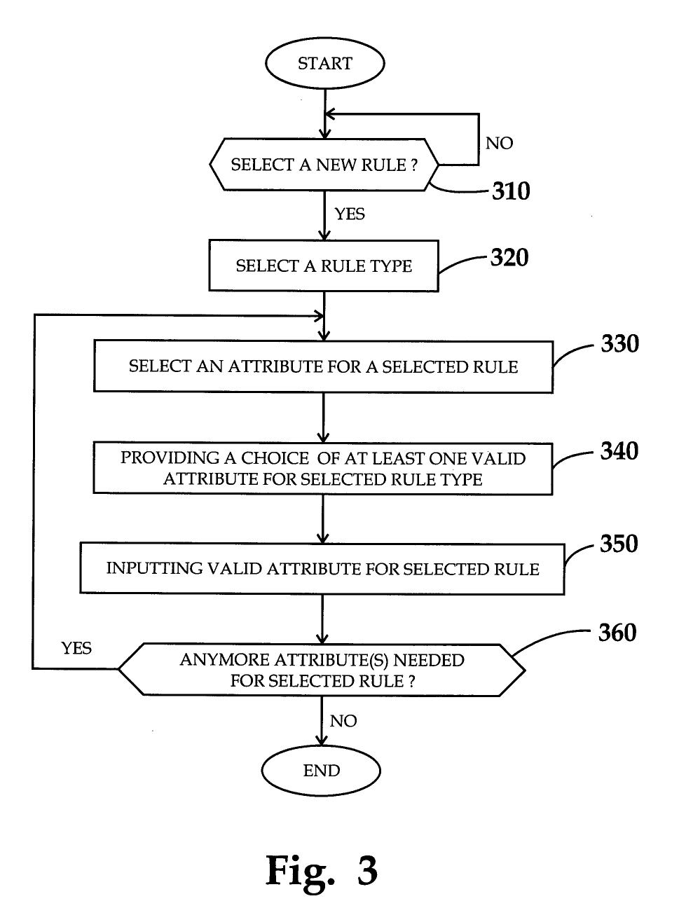

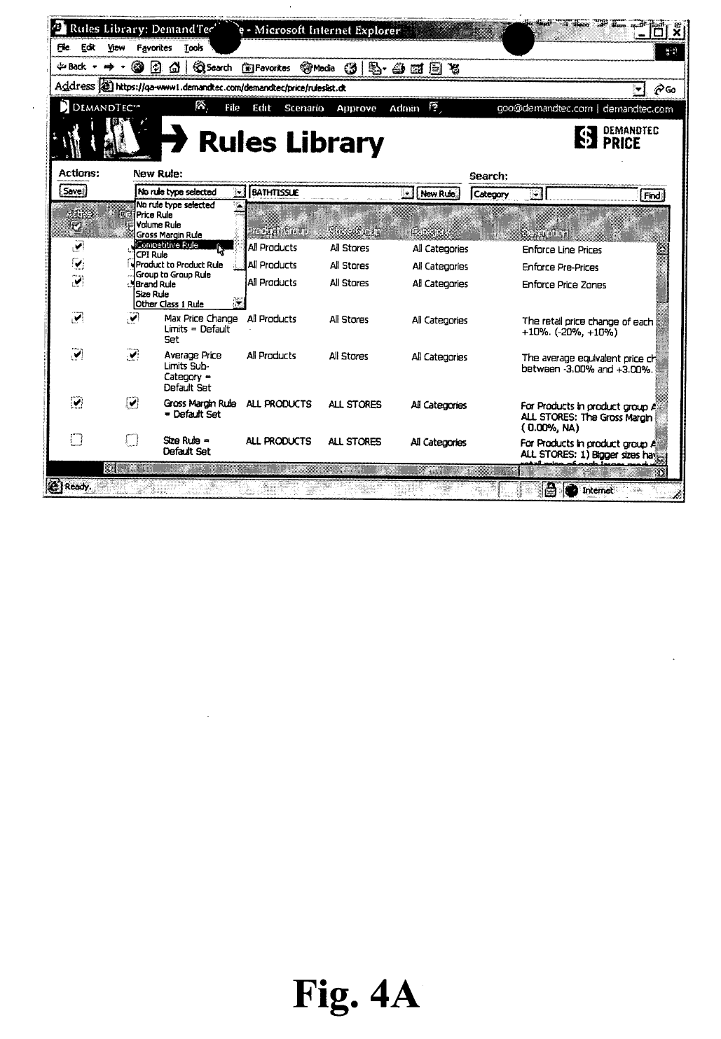

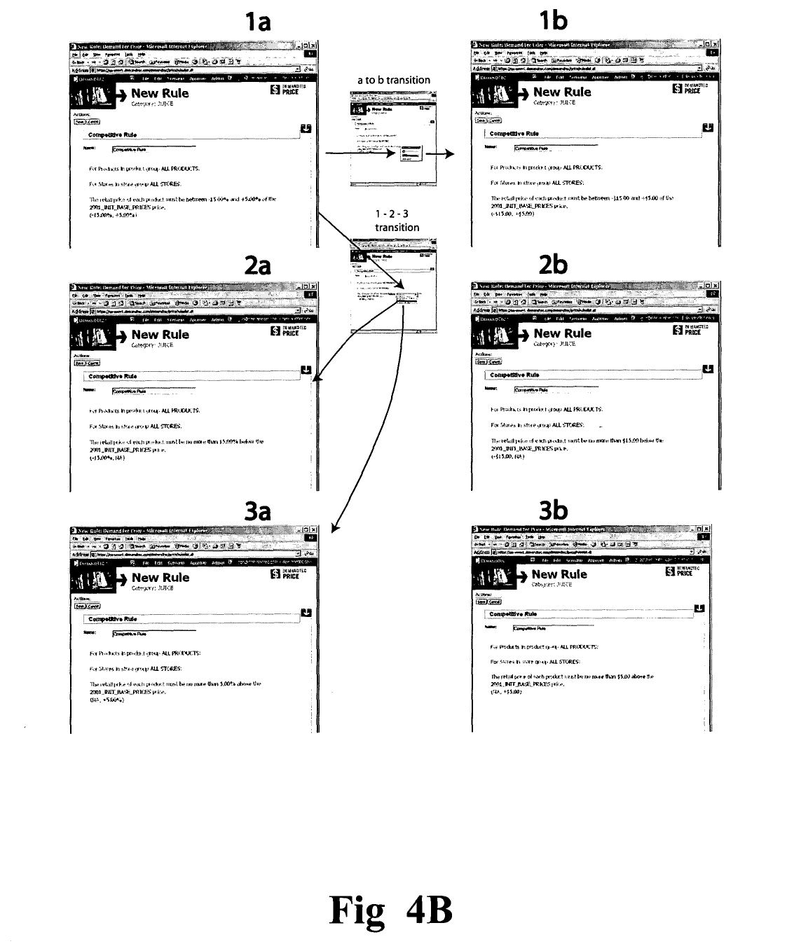

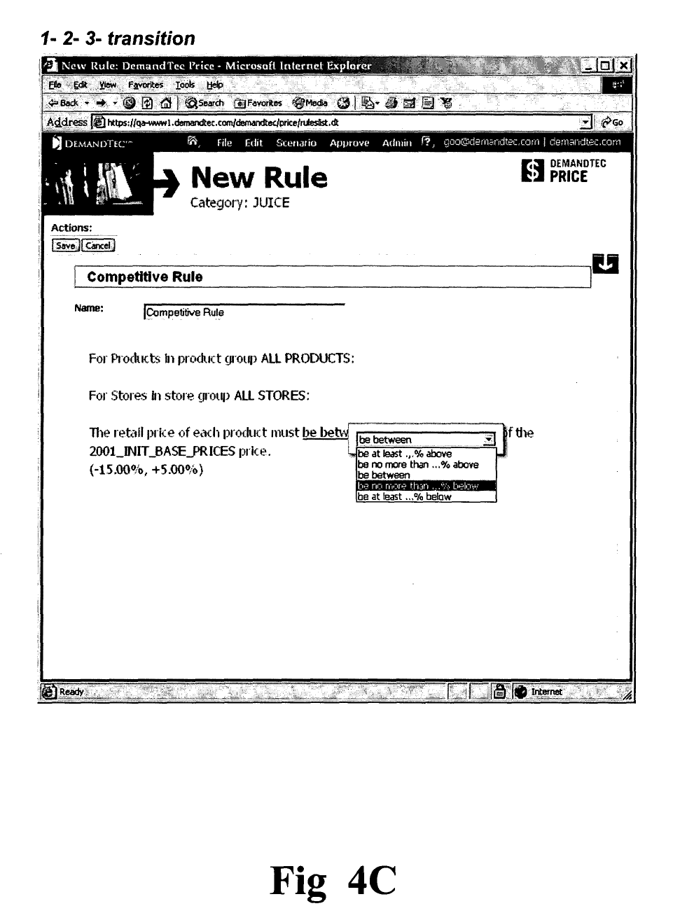

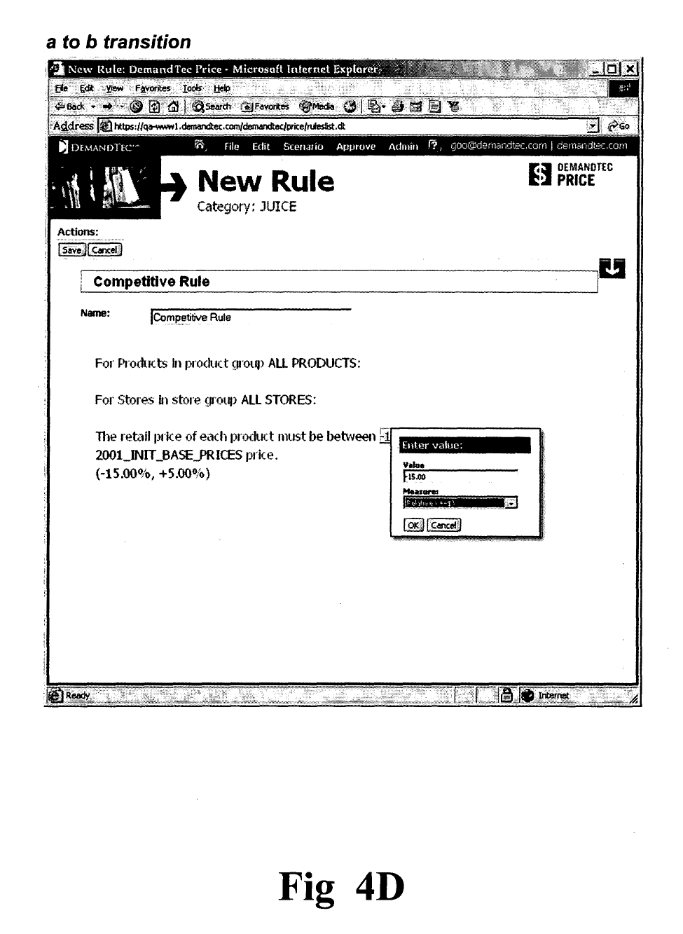

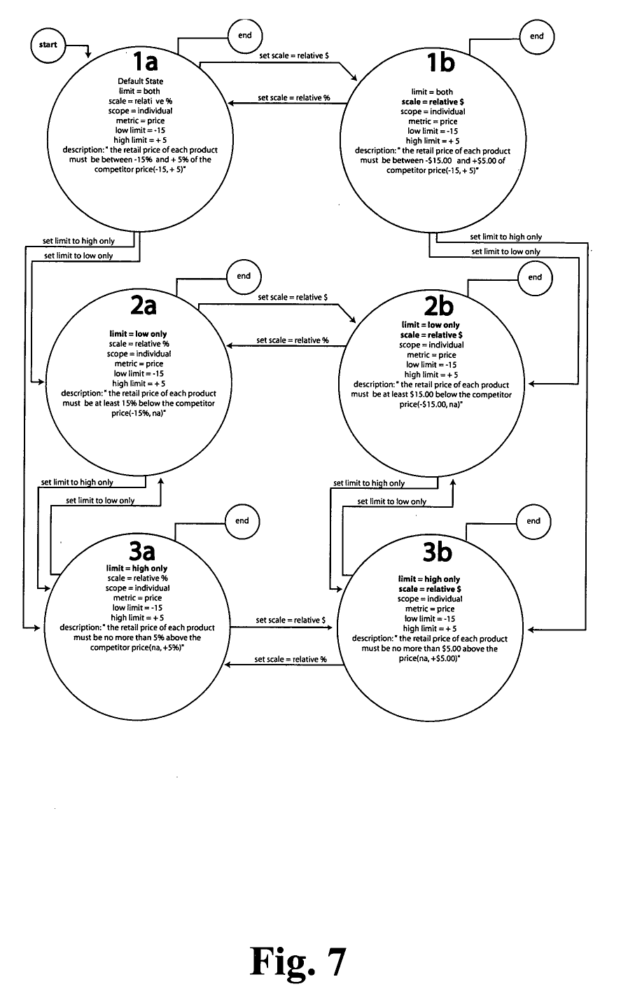

FIG. 3 is a flow diagram illustrating the construction of rules and associated rule attributes. FIG. 4A illustrates a choice of rule types, and in this example, a competitive rule. FIG. 4B illustrates an exemplary set of screen shots for defining a new competitive rule. FIGS. 4C, 4D, 5A-5C and 6A-6C are exemplary screen shots illustrating the construction of the new competitive rule. FIG. 7 illustrates state transitions for the construction of the new competitive rule. Appendix A illustrates sample State Maps for rule engine 120. Tables A-C below illustrate an exemplary set of predetermined rule types and associated rule attributes.

In step 310, when the user selects a “new rule” icon, user interface 110 provides a menu of rule types, for example a competitive rule or average price rule (see tables 1-3). Having selected a competitive rule in step 320 as shown in FIG. 4A, the user is also able to select “all products” in the category or a subset of products using an edit rule screen. In addition, the user is also able to select “all stores” or a subset of competitive stores.

As shown in the screenshot of FIG. 4C, the user can navigate state transitions between State 1a/b, State 2a/b and State 3a/b, which correspond with valid rule attributes consistent with the new competitive rule for the selected product(s) and store(s). In this example, the user selects a valid attribute, e.g. “upper/lower bounds”, for the competitive rule (step 330). User interface 110 provides a drop-down menu choice of “be between”, “be at least . . . % above”, “be no more than . . . . % above”, “be no more than . . . % below” and “be at least . . . % below” (see step 340). The user will be displayed both upper and lower bounds for all selections that do not contain “. . .” For those selections that contain “. . .” only a single numerical attribute will be displayed and this numerical value will be inserted in place of the “. . .”

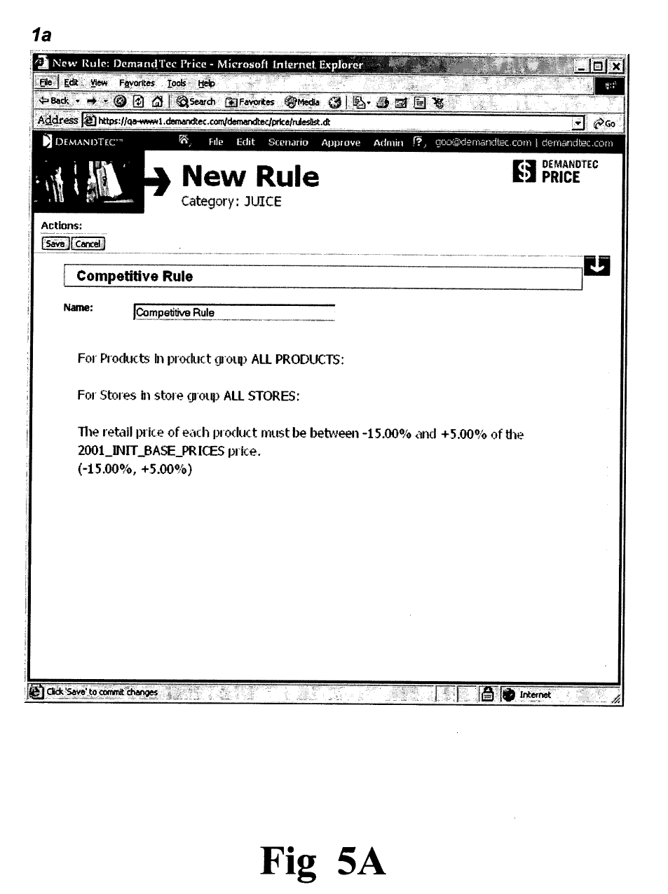

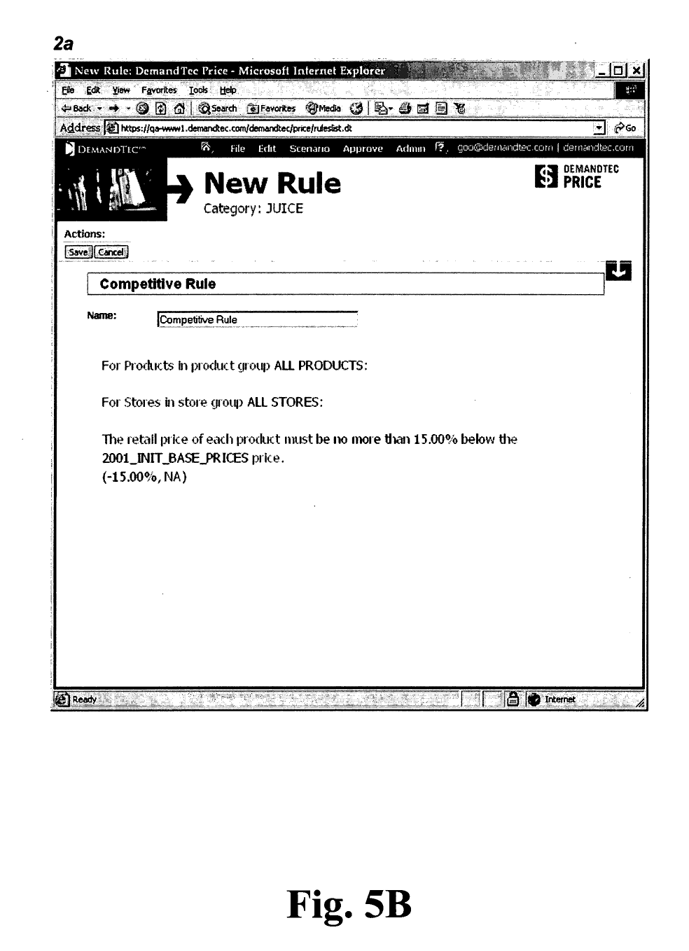

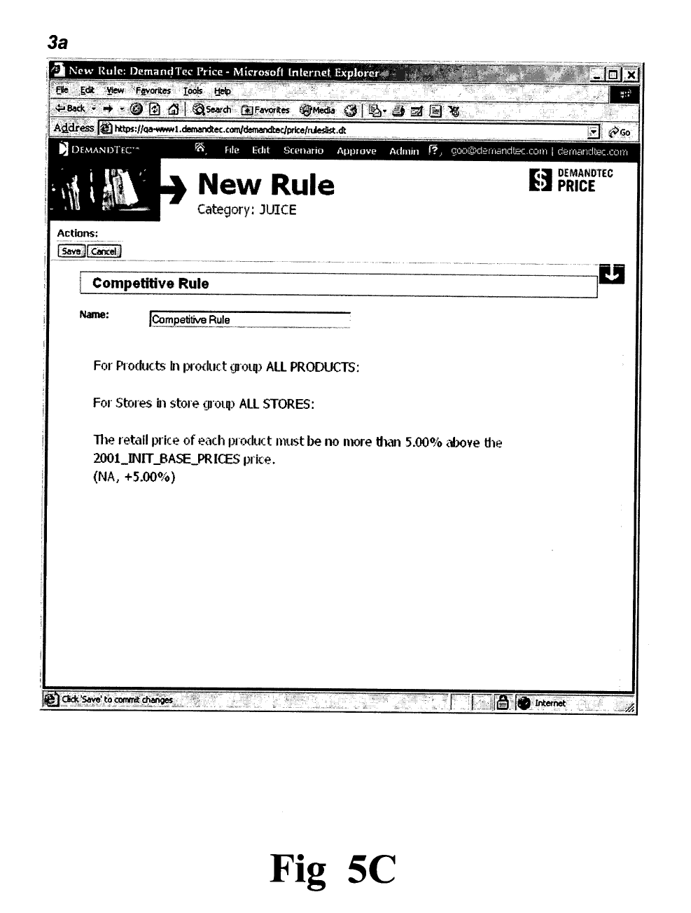

FIGS. 5A-5C are screenshots illustrating the user inputting percentage upper and/or lower bounds for the competitive rule (steps 350 and 360). In FIG. 5A, the user has selected a lower bound of −15% and an upper bound of +5% of initial base price for the select product and store (see State 1a of FIG. 7). FIG 5B illustrates a second example where the user has selected a lower bound of −15% and no upper bound (see State 2a of FIG. 7). Conversely, as shown in FIG 5C, the user selected an upper bound of +5%, and without defining a lower bound (see State 3a of FIG. 7).

Referring now to screenshot of FIG. 4D, the user has opted to select relative upper and/or bounds for the competitive rule. Referring again to the screenshot of FIG. 4C, the user can navigate state transitions between State 1b, State 2b and State 3b, which correspond with relative upper and/or lower bounds for the selected product(s) and store(s) (step 340).

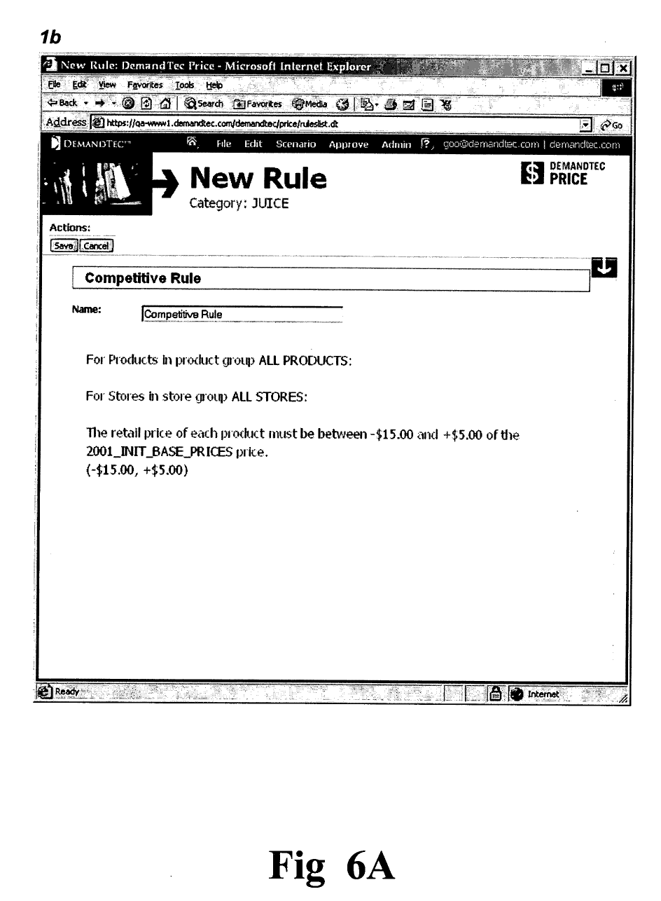

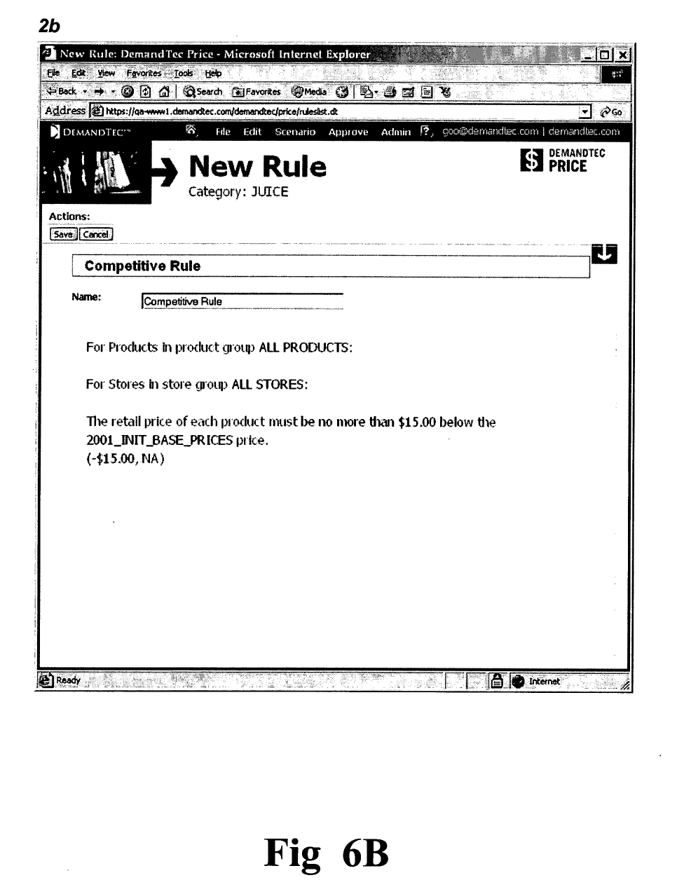

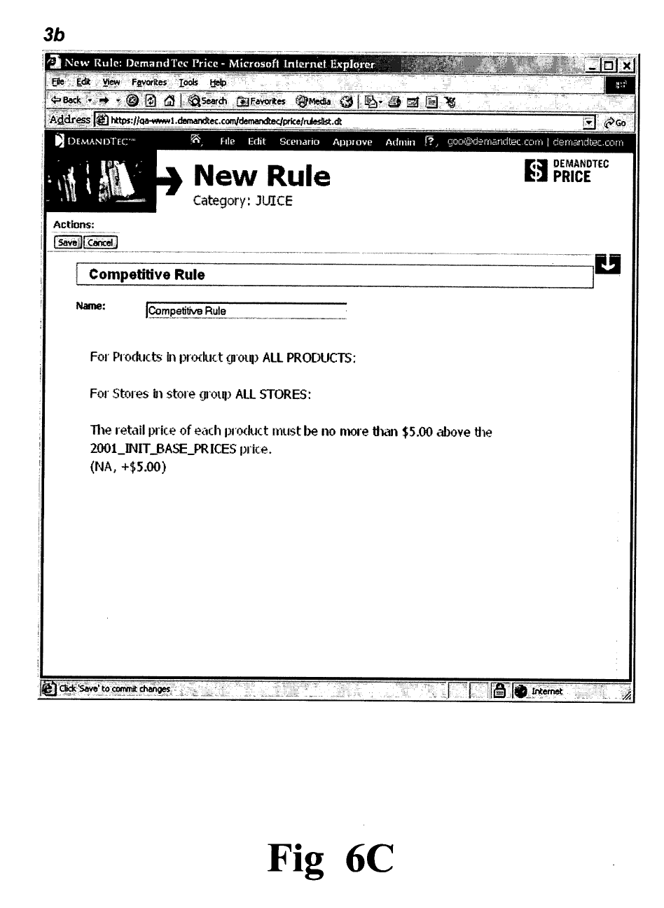

Steps 350 and 360 as further illustrated by the screenshots of FIGS. 6A-6C. In FIG. 6A, the user has selected a lower bound of −$15 and an upper bound of +$5 of initial base price for the select product and store (see State 1b of FIG. 7). FIG. 6B illustrates a second example where the user has selected a lower bound of −$15 and no upper bound (see State 2b of FIG. 7). Conversely, as shown in FIG. 6C, the user selected an upper bound of +$5, and without defining a lower bound see State 3b of FIG. 7).

Although exemplary bounds, e.g. +5%, −15%, +$5, and −$15, are described in the above examples, rules user interface 110 enables the user is able to change these bounds to suit the product(s) and store(s). In addition, these bounds can be defined in the order convenient to the user.

As shown in the State diagram of FIG. 7, state machines 216 keep track of past states, and valid forward looking valid states. For example, from State 1a the user can transition to State 1b, or State 2a or State 3a. User interface 110 uses composite map 214 to provide a roadmap for the user to define consistent and valid rules and rule attributes.

Rules user interface 110 of the present invention provides many advantages to the user. The user is able to focus on the business aspects of rule definition, since rules interface 110 takes care of structure and validity of rules and associated rule attributes.

In addition to the ease of use, the user is also able define rules in response to different conditions. For example, rules can be defined for price updates in response to cost changes or competitor price changes. They are also used for defining relationships between products, for example rules defining the size relationships, brand relationships, and other product relationships.

TABLE A

| Code | RuleTypeName | RuleType | ScopeName | Scope | ScaleName | Scale |
|---|---|---|---|---|---|---|
| 0.0.0.0.1 | Price Rule | 0 | Aggregated | 0 | Relative (in %) | 0 |
| 0.0.0.0.2 | Price Rule | 0 | Aggregated | 0 | Relative (in %) | 0 |
| 0.0.0.0.3 | Price Rule | 0 | Aggregated | 0 | Relative (in %) | 0 |
| 0.0.0.2.1 | Price Rule | 0 | Aggregated | 0 | Relative (in %) | 0 |
| 0.0.0.2.2 | Price Rule | 0 | Aggregated | 0 | Relative (in %) | 0 |
| 0.0.0.2.3 | Price Rule | 0 | Aggregated | 0 | Relative (in %) | 0 |
| 0.1.0.0.1 | Price Rule | 0 | Individual | 1 | Relative (in %) | 0 |
| 0.1.0.0.2 | Price Rule | 0 | Individual | 1 | Relative (in %) | 0 |
| 0.1.0.0.3 | Price Rule | 0 | Individual | 1 | Relative (in %) | 0 |
| 0.1.1.0.1 | Price Rule | 0 | Individual | 1 | Relative (in $) | 1 |
| 0.1.1.0.2 | Price Rule | 0 | Individual | 1 | Relative (in $) | 1 |
| 0.1.1.0.3 | Price Rule | 0 | Individual | 1 | Relative (in $) | 1 |
| 0.1.2.0.1 | Price Rule | 0 | Individual | 1 | Absolute | 2 |
| 0.1.2.0.2 | Price Rule | 0 | Individual | 1 | Absolute | 2 |
| 0.1.2.0.3 | Price Rule | 0 | Individual | 1 | Absolute | 2 |
| 0.2.1.0.1 | Price Rule | 0 | Aggregated | 0 | Relative (in %) | 0 |
| 0.2.1.0.2 | Price Rule | 0 | Aggregated | 0 | Relative (in %) | 0 |
| 0.2.1.0.3 | Price Rule | 0 | Aggregated | 0 | Relative (in %) | 0 |
| 2.1.0.0.1 | Cross Store Rule | 2 | Individual | 1 | Relative (in %) | 0 |
| 2.1.0.0.2 | Cross Store Rule | 2 | Individual | 1 | Relative (in %) | 0 |
| 2.1.0.0.3 | Cross Store Rule | 2 | Individual | 1 | Relative (in %) | 0 |
| 2.1.1.0.1 | Cross Store Rule | 2 | Individual | 1 | Relative (in $) | 1 |
| 2.1.1.0.2 | Cross Store Rule | 2 | Individual | 1 | Relative (in $) | 1 |
| 2.1.1.0.3 | Cross Store Rule | 2 | Individual | 1 | Relative (in $) | 1 |
| 3.1.0.0.1 | Brand Rule | 3 | Individual | 1 | Relative (in %) | 0 |
| 3.1.0.0.2 | Brand Rule | 3 | Individual | 1 | Relative (in %) | 0 |
| 3.1.0.0.3 | Brand Rule | 3 | Individual | 1 | Relative (in %) | 0 |
| 3.1.0.2.1 | Brand Rule | 3 | Individual | 1 | Relative (in %) | 0 |
| 3.1.0.2.2 | Brand Rule | 3 | Individual | 1 | Relative (in %) | 0 |
| 3.1.0.2.3 | Brand Rule | 3 | Individual | 1 | Relative (in %) | 0 |
| 3.1.1.0.1 | Brand Rule | 3 | Individual | 1 | Relative (in $) | 1 |
| 3.1.1.0.2 | Brand Rule | 3 | Individual | 1 | Relative (in $) | 1 |
| 3.1.1.0.3 | Brand Rule | 3 | Individual | 1 | Relative (in $) | 1 |
| 4.1.1.0.1 | Size Rule | 4 | Individual | 1 | Relative (in %) | 0 |
| 4.1.1.0.2 | Size Rule | 4 | Individual | 1 | Relative (in %) | 0 |
| 4.1.1.1.1 | Size Rule | 4 | Individual | 1 | Relative (in $) | 1 |
| 5.1.0.0.1 | Group to Group Rule | 5 | Individual | 1 | Relative (in %) | 0 |
| 5.1.0.0.2 | Group to Group Rule | 5 | Individual | 1 | Relative (in %) | 0 |
| 5.1.0.0.3 | Group to Group Rule | 5 | Individual | 1 | Relative (in %) | 0 |
| 5.1.0.2.1 | Group to Group Rule | 5 | Individual | 1 | Relative (in %) | 0 |
| 5.1.0.2.2 | Group to Group Rule | 5 | Individual | 1 | Relative (in %) | 0 |
| 5.1.0.2.3 | Group to Group Rule | 5 | Individual | 1 | Relative (in %) | 0 |
| 5.1.1.0.1 | Group to Group Rule | 5 | Individual | 1 | Relative (in $) | 1 |
| 5.1.1.0.2 | Group to Group Rule | 5 | Individual | 1 | Relative (in $) | 1 |
| 5.1.1.0.3 | Group to Group Rule | 5 | Individual | 1 | Relative (in $) | 1 |
| 6.1.0.0.1 | Competitor Price Rule | 6 | Individual | 1 | Relative (in %) | 0 |
| 6.1.0.0.2 | Competitor Price Rule | 6 | Individual | 1 | Relative (in %) | 0 |
| 6.1.0.0.3 | Competitor Price Rule | 6 | Individual | 1 | Relative (in %) | 0 |
| 6.1.1.0.1 | Competitor Price Rule | 6 | Individual | 1 | Relative (in $) | 1 |
| 6.1.1.0.2 | Competitor Price Rule | 6 | Individual | 1 | Relative (in $) | 1 |
| 6.1.1.0.3 | Competitor Price Rule | 6 | Individual | 1 | Relative (in $) | 1 |
| 7.1.0.0.0 | Enforce Line Price | 7 | Individual | 1 | Relative (in %) | 0 |
| 8.0.0.0.0 | Enforce Pre-Prices | 8 | Aggregated | 0 | Relative (in %) | 0 |
| 9.0.0.0.0 | Enforce Price Zones | 9 | Aggregated | 0 | Relative (in %) | 0 |
| 11.1.0.0.3 | Price Change Limits | 11 | Individual | 1 | Relative (in %) | 0 |
| 12.0.0.2.3 | Average Price Limits | 12 | Aggregated | 0 | Relative (in %) | 0 |
| 13.1.2.0.0 | Allowable Last Digits | 13 | Individual | 1 | Absolute | 2 |
| 14.1.0.0.1 | Product to Product Rule | 14 | Individual | 1 | Relative (in %) | 0 |
| 14.1.0.0.2 | Product to Product Rule | 14 | Individual | 1 | Relative (in %) | 0 |
| 14.1.0.0.3 | Product to Product Rule | 14 | Individual | 1 | Relative (in %) | 0 |
| 14.1.0.2.1 | Product to Product Rule | 14 | Individual | 1 | Relative (in %) | 0 |
| 14.1.0.2.2 | Product to Product Rule | 14 | Individual | 1 | Relative (in %) | 0 |
| 14.1.0.2.3 | Product to Product Rule | 14 | Individual | 1 | Relative (in %) | 0 |
| 14.1.1.0.1 | Product to Product Rule | 14 | Individual | 1 | Relative (in $) | 1 |
| 14.1.1.0.2 | Product to Product Rule | 14 | Individual | 1 | Relative (in $) | 1 |
| 14.1.1.0.3 | Product to Product Rule | 14 | Individual | 1 | Relative (in $) | 1 |
| 15.0.0.3.1 | Volume Rule | 15 | Aggregated | 0 | Relative (in %) | 0 |
| 16.0.2.1.1 | Gross Margin Rule | 16 | Aggregated | 0 | Absolute | 2 |
| | Gross Margin Rule | 16 | Individual | 1 | Relative (in %) | 0 |
| | Gross Margin Rule | 16 | Individual | 1 | Relative (in %) | 0 |
| | Gross Margin Rule | 16 | Individual | 1 | Relative (in %) | 0 |
| 16.1.2.1.1 | Gross Margin Rule | 16 | Individual | 1 | Absolute | 2 |
| 16.1.2.1.2 | Gross Margin Rule | 16 | Individual | 1 | Absolute | 2 |
| 16.1.2.1.3 | Gross Margin Rule | 16 | Individual | 1 | Absolute | 2 |
| 17.1.0.0.1 | Other Class 1 Rule | 17 | Individual | 1 | Relative (in %) | 0 |
| 17.1.0.0.2 | Other Class 1 Rule | 17 | Individual | 1 | Relative (in %) | 0 |
| 17.1.0.0.3 | Other Class 1 Rule | 17 | Individual | 1 | Relative (in %) | 0 |
| 17.1.0.2.1 | Other Class 1 Rule | 17 | Individual | 1 | Relative (in %) | 0 |
| 17.1.0.2.2 | Other Class 1 Rule | 17 | Individual | 1 | Relative (in %) | 0 |
| 17.1.0.2.3 | Other Class 1 Rule | 17 | Individual | 1 | Relative (in %) | 0 |
| 17.1.1.0.1 | Other Class 1 Rule | 17 | Individual | 1 | Relative (in $) | 1 |
| 17.1.1.0.2 | Other Class 1 Rule | 17 | Individual | 1 | Relative (in $) | 1 |
| 17.1.1.0.3 | Other Class 1 Rule | 17 | Individual | 1 | Relative (in $) | 1 |
| 18.1.0.0.1 | Other Class 2 Rule | 18 | Individual | 1 | Relative (in %) | 0 |
| 18.1.0.0.2 | Other Class 2 Rule | 18 | Individual | 1 | Relative (in %) | 0 |
| 18.1.0.0.3 | Other Class 2 Rule | 18 | Individual | 1 | Relative (in %) | 0 |
| 18.1.0.2.1 | Other Class 2 Rule | 18 | Individual | 1 | Relative (in %) | 0 |
| 18.1.0.2.2 | Other Class 2 Rule | 18 | Individual | 1 | Relative (in %) | 0 |
| 18.1.0.2.3 | Other Class 2 Rule | 18 | Individual | 1 | Relative (in %) | 0 |
| 18.1.1.0.1 | Other Class 2 Rule | 18 | Individual | 1 | Relative (in $) | 1 |
| 18.1.1.0.2 | Other Class 2 Rule | 18 | Individual | 1 | Relative (in $) | 1 |
| 18.1.1.0.3 | Other Class 2 Rule | 18 | Individual | 1 | Relative (in $) | 1 |
| 19.0.0.3.1 | Volume Floor | 19 | Aggregated | 0 | Relative (in %) | 0 |
| 20.0.0.8.1 | Profit Floor | 20 | Aggregated | 0 | Relative (in %) | 0 |
| | CPI Rule | 21 | Aggregated | 0 | Relative (in %) | 0 |
| | CPI Rule | 21 | Aggregated | 0 | Relative (in %) | 0 |
| | CPI Rule | 21 | Aggregated | 0 | Relative (in %) | 0 |
| | Multiples | 22 | | 1 | | 2 |
| 21.1.0.0.1 | Price Drift Rule | 0 | Individual | 1 | Relative (in %) | 0 |
| 21.1.0.0.2 | Price Drift Rule | 0 | Individual | 1 | Relative (in %) | 0 |
| 21.1.0.0.3 | Price Drift Rule | 0 | Individual | 1 | Relative (in %) | 0 |
| 21.1.1.0.1 | Price Drift Rule | 0 | Individual | 1 | Relative (in $) | 1 |
| 21.1.1.0.2 | Price Drift Rule | 0 | Individual | 1 | Relative (in $) | 1 |
| 21.1.1.0.3 | Price Drift Rule | 0 | Individual | 1 | Relative (in $) | 1 |

TABLE B

| Code | Negative Bound | Positive Bound |
|---|---|---|
| 0.0.0.0.1 | The average retail price of the group must not | The average retail price of the group must |
| | drop by more than 30% (−30%, NA) | increase by more than 5% (+5%, NA) |
| 0.0.0.0.2 | The average retail price of the group must drop | The average retail price of the group must not |
| | by at least 10% (NA, −10%) | increase by more than 15% (NA, +15%) |
| 0.0.0.0.3 | The average retail price change of the group | |
| | must be between −30% and +15% (−30%, | |
| | +15%) | |
| 0.0.0.2.1 | The average equivalent price of the group | The average equivalent price of the group |
| | must not drop by more than 30% (−30%, NA) | must increase by more than 5% (+5%, NA) |
| 0.0.0.2.2 | The average equivalent price of the group | The average equivalent price of the group |
| | must drop by at least 10% (NA, −10%) | must not increase by more than 15% (NA, |
| | +15%) | |
| 0.0.0.2.3 | The average equivalent price change of the | |
| | group must be between −30% and +15% | |
| | (−30%, +15%) | |
| 0.1.0.0.1 | The retail price of each product must not drop | The retail price of each product must |
| | by more than 30% (−30%, NA) | increase by more than 5% (+5%, NA) |
| 0.1.0.0.2 | The retail price of each product must drop by | The retail price of each product must not |
| | at least 10% (NA, −10%) | increase by more than 15% (NA, +15%) |
| 0.1.0.0.3 | The retail price change of each product must | |
| | be between −30% and +15% (−30%, +15%) | |
| 0.1.1.0.1 | The retail price of each product must not drop | The retail price of each product must |
| | by more than $0.70 (−$0.70, NA) | increase by more than $0.50 (+$0.50, NA) |
| 0.1.1.0.2 | The retail price of each product must drop by | The retail price of each product must not |
| | at least $0.20 (NA, −$0.20) | increase by more than $1.15 (NA, +$1.15) |
| 0.1.1.0.3 | The retail price change of each product must | |
| | be between −$0.70 and +$1.15 (−$0.70, | |
| | +$1.15) | |
| 0.1.2.0.1 | NA - can't have negative price | The retail price of each product must be at |
| | | least $0.50 (+$0.50, NA) |
| 0.1.2.0.2 | NA - can't have negative price | The retail price of each product must be no |
| | | more than $1.15 (NA, +$1.15) |
| 0.1.2.0.3 | The retail price of each product must be | |
| | between $0.50 and $1.15 (+0.50, +1.15) | |
| 0.2.1.0.1 | The revenue weighted equivalent price of the | The revenue weighted equivalent price of the |
| | group must not drop by more than 30% (−30%, | group must increase by more than 5% (+5%, |
| | NA) | NA) |
| 0.2.1.0.2 | The revenue weighted equivalent price of the | The revenue weighted equivalent price of the |
| | group must drop by at least 10% (NA, −10%) | group must not increase by more than 15% |
| | | (NA, +15%) |
| 0.2.1.0.3 | The revenue weighted equivalent price change | |
| | of the group must be between −30% and +15% | |
| | (−30%, +15%) | |
| 2.1.0.0.1 | Prices of the group are allowed to be different | Prices of the group are allowed to be different |
| | from the zone price (single store pricing). The | from the zone price (single store pricing). The |
| | retail price of each product must be no more | retail price of each product must be at least |
| | than 30% below the zone price (−30%, NA) | 5% above the zone price (+5%, NA) |
| 2.1.0.0.2 | Prices of the group are allowed to be different | Prices of the group are allowed to be different |
| | from the zone price (single store pricing). The | from the zone price (single store pricing). The |
| | retail price of each product must be at least | retail price of each product must be no more |
| | 10% below the zone price (NA, −10%) | than 15% above the zone price (NA, +15%) |
| 2.1.0.0.3 | Prices of the group are allowed to be different | |
| | from the zone price (single store pricing). The | |
| | retail price of each product must be between | |
| | −30% and +15% of the zone price(−30%, +15%) | |
| 2.1.1.0.1 | Prices of the group are allowed to be different | Prices of the group are allowed to be different |
| | from the zone price (single store pricing). The | from the zone price (single store pricing). The |
| | retail price of each product must be no more | retail price of each product must be at least |
| | than $1.15 below the zone price (−$1.15, NA) | $0.50 above the zone price (+$0.50, NA) |
| 2.1.1.0.2 | Prices of the group are allowed to be different | Prices of the group are allowed to be different |
| | from the zone price (single store pricing). The | from the zone price (single store pricing). The |
| | retail price of each product must be at least | retail price of each product must be no more |
| | $0.70 below the zone price (NA, −$0.70) | than $0.50 above the zone price (NA, +$0.50) |
| 2.1.1.0.3 | Prices of the group are allowed to be different | |
| | from the zone price (single store pricing). The | |
| | retail price of each product must be between | |
| | −$1.15 and +$0.50 of the zone price (−$1.15, | |
| | +$0.50 | |
| 3.1.0.0.1 | The retail price of each [Brand Class 1] | The retail price of each [Brand Class 1] |
| | product must be no more than 30% below the | product must be at least 5% above the |
| | corresponding [Brand Class 2] product | corresponding [Brand Class 2] product (+5%, |
| | (−30%, NA) | NA) |
| 3.1.0.0.2 | The retail price of each [Brand Class 1] | The retail price of each [Brand Class 1] |
| | product must be at least 10% below the | product must be no more than 15% above |
| | corresponding [Brand Class 2] product | the corresponding [Brand Class 2] product |
| | (NA, −10%) | (NA, +15%) |
| 3.1.0.0.3 | The retail price of each [Brand Class 1] | |
| | product must be between −30% and +15% of | |
| | the corresponding [Brand Class 2] product | |
| | (−30%, +15%) | |
| 3.1.0.2.1 | The equivalent price of each [Brand Class 1] | The equivalent price of each [Brand Class |
| | product must be no more than 30% below the | 1] product must be at least 5% above the |
| | corresponding [Brand Class 2] product | corresponding [Brand Class 2] product (+5%, |
| | (−30%, NA) | NA) |
| 3.1.0.2.2 | The equivalent price of each [Brand Class 1] | The equivalent price of each [Brand Class 1] |
| | product must be at least 10% below the | product must be no more than 15% above |
| | corresponding [Brand Class 2] product | the corresponding [Brand Class 2] product |
| | (NA, −10%) | (NA, +15%) |
| 3.1.0.2.3 | The equivalent price of each [Brand Class 1] | |
| | product must be between −30% and +15% of | |
| | the corresponding [Brand Class 2] product | |
| | (−30%, +15%) | |
| 3.1.1.0.1 | The retail price of each [Brand Class 1] | The retail price of each [Brand Class 1] |
| | product must be no more than $0.70 below the | product must be at least $0.50 above the |
| | corresponding [Brand Class 2] product | corresponding [Brand Class 2] product |
| | (−$0.70, NA) | (+$0.50, NA) |
| 3.1.1.0.2 | The retail price of each [Brand Class 1] | The retail price of each [Brand Class 1] |
| | product must be at least $0.20 below the | product must be no more than $1.15 above |
| | corresponding [Brand Class 2] product | the corresponding [Brand Class 2] product |
| | (NA, −$0.20) | (NA, +$1.15) |
| 3.1.1.0.3 | The retail price of each [Brand Class 1] | |
| | product must be between −$0.70 and +$1.15 of | |
| | the corresponding [Brand Class 2] product | |
| | (−$0.70, +$1.15) | |
| 4.1.1.0.1 | | The retail price of each larger product must |
| | | be at least 5% above the corresponding next |
| | | smaller product (+5%, NA) |
| 4.1.1.0.2 | | The equivalent price of each larger product |
| | | must be at least 5% above the corresponding |
| | | next smaller product (+5%, NA) |
| 4.1.1.1.1 | | The retail price of each larger product must |
| | | be at least $0.50 above the corresponding |
| | | next smaller product (+$0.50, NA) |
| 5.1.0.0.1 | The retail price of each product in [Group A] | The retail price of each product in [Group A] |
| | must be no more than 30% below the lowest | must be at least 5% above the lowest priced |
| | priced product in [Group B] (−30%, NA) | product in [Group B] (+5%, NA) |
| 5.1.0.0.2 | The retail price of each product in [Group A] | The retail price of each product in [Group A] |
| | must be at least 10% below the highest priced | must be no more than 15% above the highest |
| | product in [Group B] (NA, −10%) | priced product in [Group B] (NA, +15%) |
| 5.1.0.0.3 | The retail price of each product in [Group A] | |
| | must be between −30% and +15% of the price | |
| | of every product in [Group B] (−30%, +15%) | |
| 5.1.0.2.1 | The equivalent price of each product in [Group | The equivalent price of each product in |
| | A] must be no more than 30% below the lowest | [Group A] must be at least 5% above the |
| | priced product in [Group B] (−30%, NA) | lowest priced product in [Group B] (+5%, NA) |
| 5.1.0.2.2 | The equivalent price of each product in [Group | The equivalent price of each product in |
| | A] must be at least 10% below the highest | [Group A] must be no more than 15% above |
| | priced product in [Group B] (NA, −10%) | the highest priced product in [Group B] |
| | | (NA, +15%) |
| 5.1.0.2.3 | The equivalent price of each product in [Group | |
| | A] must be between −30% and +15% of the | |
| | price of every product in [Group B] | |
| | (−30%, +15%) | |
| 5.1.1.0.1 | The retail price of each product in [Group A] | The retail price of each product in [Group A] |
| | must be no more than $0.70 below the lowest | must be at least $0.50 above the lowest |
| | priced product in [Group B] (−$0.70, NA) | priced product in [Group B] (+$0.50, NA) |
| 5.1.1.0.2 | The retail price of each product in [Group A] | The retail price of each product in [Group A] |
| | must be at least $0.20 below the highest priced | must be no more than $1.15 above the |
| | product in [Group B] (NA, −$0.20) | highest priced product in [Group B] |
| | | (NA, +$1.15) |
| 5.1.1.0.3 | The retail price of each product in [Group A] | |
| | must be between −$0.70 and +$1.15 of the | |
| | price of every product in [Group B] | |
| | (−$0.70, +$1.15) | |
| 6.1.0.0.1 | The retail price of each product must be no | The retail price of each product must be at |
| | more than 30% below the [Compset 1] price | least 5% above the [Compset 1] price |
| | (−30%, NA) | (+5%, NA) |
| 6.1.0.0.2 | The retail price of each product must be at | The retail price of each product must be no |
| | least 10% below the [Compset 1] price | more than 15% above the [Compset 1] price |
| | (NA, −10%) | (NA, +15%) |
| 6.1.0.0.3 | The retail price of each product must be | |
| | between −30% and +15% of the [Compset 1] | |
| | price (−30%, +15%) | |
| 6.1.1.0.1 | The retail price of each product must be no | The retail price of each product must be at |
| | more than $0.70 below the [Compset 1] price | least $0.50 above the [Compset 1] price |
| | (−$0.70, NA) | (+$0.50, NA) |
| 6.1.1.0.2 | The retail price of each product must be at | The retail price of each product must be no |
| | least $0.20 below the [Compset 1] price | more than $1.15 above the [Compset 1] price |
| | (NA, −$0.20) | (NA, +$1.15) |
| 6.1.1.0.3 | The retail price of each product must be | |
| | between −$0.70 and +$1.15 of the [Compset 1] | |
| | price (−$0.70, +$1.15) | |
| 7.1.0.0.0 | Enforce Line Prices | |
| 8.0.0.0.0 | Enforce PrePrices | |
| 9.0.0.0.0 | Enforce Price Zones | |
| 11.1.0.0.3 | The retail price change of each product must | |
| | be between −30% and +15% (−30%, +15%) | |
| 12.0.0.2.3 | The average equivalent price change of any | |
| | sub-category must be between −10% and +5% | |
| | (−10%, +5%) | |
| 13.1.2.0.0 | Apply this rule only to products priced above | |
| | $0.00: Retail prices for products must end in | |
| | one of these | |
| | numbers:.(.00, .10, .20, .21, .22, .23, .24, .25, | |
| | .26, .27, .28, .29, .30, .40, .50, .60, .70, .80, .90) | |
| 14.1.0.0.1 | The retail price of [Product A] must be no more | The retail price of [Product A] must be at |
| | than 30% below the price of [Product B] | least 5% above the price of [Product B] |
| | (−30%, NA) | (+5%, NA) |
| 14.1.0.0.2 | The retail price of [Product A] must be at least | The retail price of [Product A] must be no |
| | 10% below the price of [Product B] (NA, −10%) | more than 15% above the price of [Product B] |
| | | (NA, +15%) |
| 14.1.0.0.3 | The retail price of [Product A] must be between | |
| | −30% and +15% of [Product B] (−30%, +15%) | |
| 14.1.0.2.1 | The equivalent price of [Product A] must be no | The equivalent price of [Product A] must be |
| | more than 30% below the price of [Product B] | at least 5% above the price of [Product B] |
| | (−30%, NA) | (+5%, NA) |
| 14.1.0.2.2 | The equivalent price of [Product A] must be at | The equivalent price of [Product A] must be |
| | least 10% below the price of [Product B] | no more than 15% above the price of |
| | (NA, −10%) | [Product B] (NA, +15%) |
| 14.1.0.2.3 | The equivalent price of [Product A] must be | |
| | between −30% and +15% of [Product B] (−30%, | |
| | +15%) | |
| 14.1.1.0.1 | The retail price of [Product A] must be no more | The retail price of [Product A] must be at |
| | than $0.70 below the price of [Product B] | least $0.50 above the price of [Product B] |
| | (−$0.70, NA) | (+$0.50, NA) |
| 14.1.1.0.2 | The retail price of [Product A] must be at least | The retail price of [Product A] must be no |
| | $0.20 below the price of [Product B] | more than $1.15 above the price of |
| | (NA, −$0.20) | [Product B] (NA, +$1.15) |
| 14.1.1.0.3 | The retail price of [Product A] must be between | |
| | −$0.70 and +$1.15 of | |
| | [Product B] (−$0.70, +$1.15) | |
| 15.0.0.3.1 | The equivalent volume of the group must not | The equivalent volume of the group must |
| | drop by more than 2% (−2%, NA) | increase by more than 1% (+1%, NA) |
| 16.0.2.1.1 | The average Gross Margin of the group must | The average Gross Margin of the group must |
| | be at least −30% (−30%, NA) | be at least +5% (+5%, NA) |
| 16.1.2.1.1 | The Gross Margin of each product must be at | The Gross Margin of each product must be at |
| | least −30% (−30%, NA) | least +5% (+5%, NA) |
| 16.1.2.1.2 | The Gross Margin of each product must be no | The Gross Margin of each product must be |
| | more than −5% (NA, −5%) | no more than +5% (NA, +5%) |
| 16.1.2.1.3 | The Gross Margin of each product must be | |
| | between −30% and +15% (−30%, +15%) | |
| 17.1.0.0.1 | The retail price of each [Other Class A] product | The retail price of each [Other Class A] |
| | must be no more than 30% below the | product must be at least 5% above the |
| | corresponding [Other Class B] product | corresponding [Other Class B] product |
| | (−30%, NA) | (+5%, NA) |
| 17.1.0.0.2 | The retail price of each [Other Class A] product | The retail price of each [Other Class A] |
| | must be at least 10% below the corresponding | product must be no more than 15% above |
| | [Other Class B] product (NA, −10%) | the corresponding [Other Class B] product |
| | | (NA, +15%) |
| 17.1.0.0.3 | The retail price of each [Other Class A] product | |
| | must be between −30% and +15% of the | |
| | corresponding [Other Class B] product | |
| | (−30%, +15%) | |
| 17.1.0.2.1 | The equivalent price of each [Other Class A] | The equivalent price of each [Other Class A] |
| | product must be no more than 30% below the | product must be at least 5% above the |
| | corresponding [Other Class B] product | corresponding [Other Class B] product |
| | (−30%, NA) | (+5%, NA) |
| 17.1.0.2.2 | The equivalent price of each [Other Class A] | The equivalent price of each [Other Class A] |
| | product must be at least 10% below the | product must be no more than 15% above |
| | corresponding [Other Class B] product | the corresponding [Other Class B] product |
| | (NA, −10%) | (NA, +15%) |
| 17.1.0.2.3 | The equivalent price of each [Other Class A] | |
| | product must be between −30% and +15% of | |
| | the corresponding [Other Class B] product | |
| | (−30%, +15%) | |
| 17.1.1.0.1 | The retail price of each [Other Class A] product | The retail price of each [Other Class A] |
| | must be no more than $0.70 below the | product must be at least $0.50 above the |
| | corresponding [Other Class B] product (−$0.70, | corresponding [Other Class B] product |
| | NA) | (+$0.50, NA) |
| 17.1.1.0.2 | The retail price of each [Other Class A] product | The retail price of each [Other Class A] |
| | must be at least $0.20 below the | product must be no more than $1.15 above |
| | corresponding [Other Class B] product | the corresponding [Other Class B] product |
| | (NA, −$0.20) | (NA, +$1.15) |
| 17.1.1.0.3 | The retail price of each [Other Class A] product | |
| | must be between −$0.70 and +$1.15 of the | |
| | corresponding [Other Class B] product | |
| | (−$0.70, +$1.15) | |
| 18.1.0.0.1 | The retail price of each [Other Class C] | The retail price of each [Other Class C] |
| | product must be no more than 30% below the | product must be at least 5% above the |
| | corresponding [Other Class D] product | corresponding [Other Class D] product |
| | (−30%, NA) | (+5%, NA) |
| 18.1.0.0.2 | The retail price of each [Other Class C] | The retail price of each [Other Class C] |
| | product must be at least 10% below the | product must be no more than 15% above |
| | corresponding [Other Class D] product | the corresponding [Other Class D] product |
| | (NA, −10%) | (NA, +15%) |
| 18.1.0.0.3 | The retail price of each [Other Class C] | |
| | product must be between −30% and +15% of | |
| | the corresponding [Other Class D] product | |
| | (−30%, +15%) | |
| 18.1.0.2.1 | The equivalent price of each [Other Class C] | The equivalent price of each [Other Class C] |
| | product must be no more than 30% below the | product must be at least 5% above the |
| | corresponding [Other Class D] product | corresponding [Other Class D] product |
| | (−30%, NA) | (+5%, NA) |
| 18.1.0.2.2 | The equivalent price of each [Other Class C] | The equivalent price of each [Other Class C] |
| | product must be at least 10% below the | product must be no more than 15% above |
| | corresponding [Other Class D] product | the corresponding [Other Class D] product |
| | (NA, −10%) | (NA, +15%) |
| 18.1.0.2.3 | The equivalent price of each [Other Class C] | |
| | product must be between −30% and +15% of | |
| | the corresponding [Other Class D] product | |
| | (−30%, +15%) | |
| 18.1.1.0.1 | The retail price of each [Other Class C] | The retail price of each [Other Class C] |
| | product must be no more than $0.70 below the | product must be at least $0.50 above the |
| | corresponding [Other Class D] product | corresponding [Other Class D] product |
| | (−$0.70, NA) | (+$0.50, NA) |
| 18.1.1.0.2 | The retail price of each [Other Class C] | The retail price of each [Other Class C] |
| | product must be at least $0.20 below the | product must be no more than $1.15 above |
| | corresponding [Other Class D] product | the corresponding [Other Class D] product |
| | (NA, −$0.20) | (NA, +$1.15) |
| 18.1.1.0.3 | The retail price of each [Other Class C] | |
| | product must be between −$0.70 and +$1.15 of | |
| | the corresponding [Other Class D] product | |
| | (−$0.70, +$1.15) | |
| 19.0.0.3.1 | Equivalent volume must not drop by more than | Equivalent volume must increase by more |
| | 2% (−2%, NA) | than 1% (+1%, NA) |
| 20.0.0.8.1 | Profit must not drop by more than 2% | Profit must increase by more than 1% |
| | (−2%, NA) | (+1%, NA) |
| | The CPI <Choose CPI> must be no more | The CPI <Choose CPI> must be at least |
| | than 2.00% below 100. (−2.00, NA) | 2.00% above 100. (+2.00, NA) |
| | The CPI <Choose CPI> must be between | |
| | −2.00 and +2.00 of 100. (−2.00, +2.00) | |
| | The CPI <Choose CPI> must be no more | The CPI <Choose CPI> must be no more |
| | than 2.00% below 100. (NA, −2.00) | than 2.00% above 100. (NA, +2.00) |
| | Use multiples with a product if the optimized | |
| | price meets a specific multiple | |
| | price point and the gross margin is greater | |
| | than 5.00%. (+5.00%, NA) | |
| 21.1.0.0.1 | The retail price of each product must not drop | The retail price of each product must |
| | by more than 30% below the anchor price | increase by more than 5% above the anchor |
| | (−30%, NA) | price (+5%, NA) |
| 21.1.0.0.2 | The retail price of each product must drop by | The retail price of each product must not |
| | at least 10% below the anchor price | increase by more than 15% above the anchor |
| | (NA, −10%) | price (NA, +15%) |
| 21.1.0.0.3 | The retail price change of each product must | |
| | be between −30% and +15% of the anchor | |
| | price (−30%, +15%) | |
| 21.1.1.0.1 | The retail price of each product must not drop | The retail price of each product must |
| | by more than $0.70 below the anchor price | increase by more than $0.50 above the |
| | (−$0.70, NA) | anchor price (+$0.50, NA) |
| 21.1.1.0.2 | The retail price of each product must drop by | The retail price of each product must not |
| | at least $0.20 below the anchor price | increase by more than $1.15 above the |
| | (NA, −$0.20) | anchor price (NA, +$1.15) |
| 21.1.1.0.3 | The retail price change of each product must | |
| | be between −$0.70 and +$1.15 of the anchor | |
| | price (−$0.70, +$1.15) | |

TABLE C

| | Metric | | | | | |
|---|---|---|---|---|---|---|
| Code | Name | Metric | Limit Name | Limit | Notes | GAMS CODE |
| 0.0.0.0.1 | Price | 0 | Low Only | 1 | | ULIPEPSV |
| 0.0.0.0.2 | Price | 0 | Hi Only | 2 | | UUIPEPSV |
| 0.0.0.0.3 | Price | 0 | Low Hi Limit | 3 | | |
| 0.0.0.2.1 | Equivalent | 2 | Low Only | 1 | Redundant rules (see | ULIPEPSV |
| | price | | | | 0.0.0.0.1-0.0.0.0.3) | |
| 0.0.0.2.2 | Equivalent | 2 | Hi Only | 2 | Redundant rules (see | UUIPEPSV |
| | price | | | | 0.0.0.0.1-0.0.0.0.3) | |
| 0.0.0.2.3 | Equivalent | 2 | Low Hi Limit | 3 | Redundant rules (see | |
| | price | | | | 0.0.0.0.1-0.0.0.0.3) | |
| 0.1.0.0.1 | Price | 0 | Low Only | 1 | | ULIPEPSS |
| 0.1.0.0.2 | Price | 0 | Hi Only | 2 | | UUIPEPSS |
| 0.1.0.0.3 | Price | 0 | Low Hi Limit | 3 | | |
| 0.1.1.0.1 | Price | 0 | Low Only | 1 | | ULIPRSS |
| 0.1.1.0.2 | Price | 0 | Hi Only | 2 | | UUIRPSS |
| 0.1.1.0.3 | Price | 0 | Low Hi Limit | 3 | | |
| 0.1.2.0.1 | Price | 0 | Low Only | 1 | | ULIAPSS |
| 0.1.2.0.2 | Price | 0 | Hi Only | 2 | | UUIAPSS |
| 0.1.2.0.3 | Price | 0 | Low Hi Limit | 3 | | |
| 0.2.1.0.1 | Equivalent | 6 | Low Only | 1 | | ULIPREVSV |
| | price | | | | | |
| 0.2.1.0.2 | Equivalent | 6 | Hi Only | 2 | | UUIPREVSV |
| | price | | | | | |
| 0.2.1.0.3 | Equivalent | 6 | Low Hi Limit | 3 | | |
| | price | | | | | |
| 2.1.0.0.1 | Price | 0 | Low Only | 1 | | ULFPPVS |
| 2.1.0.0.2 | Price | 0 | Hi Only | 2 | | UUFPPVS |
| 2.1.0.0.3 | Price | 0 | Low Hi Limit | 3 | | |
| 2.1.1.0.1 | Price | 0 | Low Only | 1 | | ULFRPVS |
| 2.1.1.0.2 | Price | 0 | Hi Only | 2 | | UUFRPVS |
| 2.1.1.0.3 | Price | 0 | Low Hi Limit | 3 | | |
| 3.1.0.0.1 | Price | 0 | Low Only | 1 | | BLFPPSS |
| 3.1.0.0.2 | Price | 0 | Hi Only | 2 | | BUFPPSS |
| 3.1.0.0.3 | Price | 0 | Low Hi Limit | 3 | | |
| 3.1.0.2.1 | Equivalent | 2 | Low Only | 1 | | BLFPEPSS |
| | price | | | | | |
| 3.1.0.2.2 | Equivalent | 2 | Hi Only | 2 | | BUFPEPSS |
| | price | | | | | |
| 3.1.0.2.3 | Equivalent | 2 | Low Hi Limit | 3 | | |
| | price | | | | | |
| 3.1.1.0.1 | Price | 0 | Low Only | 1 | | BLFRPSS |
| 3.1.1.0.2 | Price | 0 | Hi Only | 2 | | BUFRPSS |
| 3.1.1.0.3 | Price | 0 | Low Hi Limit | 3 | | |
| 4.1.1.0.1 | Price | 0 | Low Only | 1 | | BLFPPSS |
| 4.1.1.0.2 | Equivalent | 2 | Low Only | 1 | | BLFPEPSS |
| | price | | | | | |
| 4.1.1.1.1 | Price | 0 | Low Only | 1 | | BLFRPSS |
| 5.1.0.0.1 | Price | 0 | Low Only | 1 | | BLFPPSS |
| 5.1.0.0.2 | Price | 0 | Hi Only | 2 | | BUFPPSS |
| 5.1.0.0.3 | Price | 0 | Low Hi Limit | 3 | | |
| 5.1.0.2.1 | Equivalent | 2 | Low Only | 1 | | BLFPEPSS |
| | price | | | | | |
| 5.1.0.2.2 | Equivalent | 2 | Hi Only | 2 | | BUFPEPSS |
| | price | | | | | |
| 5.1.0.2.3 | Equivalent | 2 | Low Hi Limit | 3 | | |
| | price | | | | | |
| 5.1.1.0.1 | Price | 0 | Low Only | 1 | | BLFPPSS |
| 5.1.1.0.2 | Price | 0 | Hi Only | 2 | | BUFPPSS |
| 5.1.1.0.3 | Price | 0 | Low Hi Limit | 3 | | |
| 6.1.0.0.1 | Price | 0 | Low Only | 1 | | ULIAPSS |
| 6.1.0.0.2 | Price | 0 | Hi Only | 2 | | UUIAPSS |
| 6.1.0.0.3 | Price | 0 | Low Hi Limit | 3 | | |
| 6.1.1.0.1 | Price | 0 | Low Only | 1 | | ULIAPSS |
| 6.1.1.0.2 | Price | 0 | Hi Only | 2 | | UUIAPSS |
| 6.1.1.0.3 | Price | 0 | Low Hi Limit | 3 | | |
| 7.1.0.0.0 | Price | 0 | No Limit | 0 | | ULFPPSV |
| 8.0.0.0.0 | Price | 0 | No Limit | 0 | | ULIPEPSS AND |
| | | | | | | UUIPEPSS |
| 9.0.0.0.0 | Price | 0 | No Limit | 0 | | No code; done by |
| | | | | | | default |
| 11.1.0.0.3 | Price | 0 | Low Hi Limit | 3 | | ULIPEPSS AND |
| | | | | | | UUIPEPSS |
| 12.0.0.2.3 | Equivalent | 2 | Low Hi Limit | 3 | this should be the demand | ULIPGEPSV AND |
| | price | | | | group level price bound | UUIPGEPSV |
| 13.1.2.0.0 | Price | 0 | No Limit | 0 | | Done outside of |
| | | | | | | GAMS |
| 14.1.0.0.1 | Price | 0 | Low Only | 1 | Same as 5.1.0.0.1-5.1.0.0.3 | BLFPPSS |
| 14.1.0.0.2 | Price | 0 | Hi Only | 2 | | BUFPPSS |
| 14.1.0.0.3 | Price | 0 | Low Hi Limit | 3 | | |
| 14.1.0.2.1 | Equivalent | 2 | Low Only | 1 | Same as 5.1.0.2.1-5.1.0.2.3 | BLFPEPSS |
| | price | | | | | |
| 14.1.0.2.2 | Equivalent | 2 | Hi Only | 2 | | BUFPEPSS |
| | price | | | | | |
| 14.1.0.2.3 | Equivalent | 2 | Low Hi Limit | 3 | | |
| | price | | | | | |
| 14.1.1.0.1 | Price | 0 | Low Only | 1 | Same as 5.1.1.0.1-5.1.1.0.3 | BLFRPSS |
| 14.1.1.0.2 | Price | 0 | Hi Only | 2 | | BUFRPSS |
| 14.1.1.0.3 | Price | 0 | Low Hi Limit | 3 | | |
| 15.0.0.3.1 | Equivalent | 3 | Low Only | 1 | | ULIPEUSA |
| | Unit | | | | | |
| 16.0.2.1.1 | Gross | 1 | Low Only | 1 | | ULFAGMSV |
| | Margin % | | | | | |
| | Gross | 1 | Low Only | 1 | | ULIRGMSS |
| | Margin % | | | | | |
| | Gross | 1 | Hi Only | 2 | | UUIRGMSS |
| | Margin % | | | | | |
| | Gross | 1 | Low Hi Limit | 3 | | |
| | Margin % | | | | | |
| 16.1.2.1.1 | Gross | 1 | Low Only | 1 | | ULFAGMSS |
| | Margin % | | | | | |
| 16.1.2.1.2 | Gross | 1 | Hi Only | 2 | | UUFAGMSS |
| | Margin % | | | | | |
| 16.1.2.1.3 | Gross | 1 | Low Hi Limit | 3 | | |
| | Margin % | | | | | |
| 17.1.0.0.1 | Price | 0 | Low Only | 1 | | BLFPPSS |
| 17.1.0.0.2 | Price | 0 | Hi Only | 2 | | BUFPPSS |
| 17.1.0.0.3 | Price | 0 | Low Hi Limit | 3 | | |
| 17.1.0.2.1 | Equivalent | 2 | Low Only | 1 | | BLFPEPSS |
| | price | | | | | |
| 17.1.0.2.2 | Equivalent | 2 | Hi Only | 2 | | BUFPEPSS |
| | price | | | | | |
| 17.1.0.2.3 | Equivalent | 2 | Low Hi Limit | 3 | | |
| | price | | | | | |
| 17.1.1.0.1 | Price | 0 | Low Only | 1 | | BLFRPSS |
| 17.1.1.0.2 | Price | 0 | Hi Only | 2 | | BUFRPSS |
| 17.1.1.0.3 | Price | 0 | Low Hi Limit | 3 | | |
| 18.1.0.0.1 | Price | 0 | Low Only | 1 | | BLFPPSS |
| 18.1.0.0.2 | Price | 0 | Hi Only | 2 | | BUFPPSS |
| 18.1.0.0.3 | Price | 0 | Low Hi Limit | 3 | | |
| 18.1.0.2.1 | Equivalent | 2 | Low Only | 1 | | BLFPEPSS |
| | price | | | | | |
| 18.1.0.2.2 | Equivalent | 2 | Hi Only | 2 | | BUFPEPSS |
| | price | | | | | |
| 18.1.0.2.3 | Equivalent | 2 | Low Hi Limit | 3 | | |
| | price | | | | | |
| 18.1.1.0.1 | Price | 0 | Low Only | 1 | | BLFRPSS |
| 18.1.1.0.2 | Price | 0 | Hi Only | 2 | | BUFRPSS |
| 18.1.1.0.3 | Price | 0 | Low Hi Limit | 3 | | |
| 19.0.0.3.1 | Equivalent | 3 | Low Only | 1 | | ULIPEUSA |
| | Unit | | | | | |
| 20.0.0.8.1 | Contribution | 8 | Low Only | 1 | | ULIPPFTSA |
| | Margin $ | | | | | |
| | CPI | | Low Only | | | ULFPCPISV |
| | CPI | | Low Hi Limit | | | UUFPCPISV |
| | CPI | | Hi Only | | | |
| | | 1 | Low Only | | | No GAMS code; |
| | | | | | | done in BOTS |
| 21.1.0.0.1 | Price | 0 | Low Only | 1 | | ULIPEPSS |
| 21.1.0.0.2 | Price | 0 | Hi Only | 2 | | UUIPEPSS |
| 21.1.0.0.3 | Price | 0 | Low Hi Limit | 3 | | |
| 21.1.1.0.1 | Price | 0 | Low Only | 1 | | ULIPRSS |
| 21.1.1.0.2 | Price | 0 | Hi Only | 2 | | UUIRPSS |
| 21.1.1.0.3 | Price | 0 | Low Hi Limit | 3 | | |

While this invention has been described in terms of several preferred embodiments, there are alterations, permutations, and equivalents which fall within the scope of this invention. For example, although reference is given to DemandTec's price optimization system, it should be understood that the invention can also integrate with other price optimization systems as well as promotion, placement, and assortment systems. In addition, this present invention is also useful for creating rules defining how products should be promoted, how they should be placed in the store, and what products should or should not be present in a given store.

It should also be noted that there are many alternative ways of implementing the apparatuses of the present invention. For example, although a drop down menu window of rules and rule attributes choices is described, there are alternative ways to display a menu of choices such as popup menus, button click drop downs, and dynamic grid generation.

In addition, while the present invention is implemented in Java™ script, the rule user interface can be implemented in one or more of many other programming languages. It is therefore intended that the following appended claims be interpreted as including all such alterations, permutations, and equivalents as fall within the true spirit and scope of the present invention.

Advantages of the invention include optimizing in the way rules and rule attributes are efficiently inputted by a less experienced user into the rules engine of a price optimization system in a more user friendly and less error prone way. Hence, the present invention provides an efficient and user friendly interface which can prompt and guide a relatively inexperienced user through the process of defining and inputting rules and rule attributes for the price optimization system. Additional advantages include readability, reduced training costs, easily adapted to other applications, easily internationalized and customized, and rule and rule attribute prompts that are concise and unambiguous.

Appendix A below includes exemplary state maps of price and brand rules for use with rules user interface 110 and rules engine 120.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Having disclosed exemplary embodiments and the best mode, modifications and variations may be made to the disclosed embodiments while remaining within the subject and spirit of the invention as defined by the following claims.

What is claimed is:

1. A method for defining rules useful in association with a rules engine of a price optimization system, comprising:
selecting a rule from a plurality of rules types;
selecting an attribute consistent with the rule type;
providing at least one valid choice for the attribute to the user; and
inputting the at least one valid choice into the rules engine.

2. The method of claim 1 wherein the rule is a competitive rule.

3. The method of claim 2 wherein the attribute is a price bound.

4. The method of claim 3 wherein the price bound is an upper bound.

5. The method of claim 3 wherein the price bound is a lower bound.

6. The method of claim 3 wherein the price bound is an absolute bound.

7. The method of claim 3 wherein the price bound is a relative bound.

8. The method of claim 7 wherein the relative bound is a percentage bound.

9. The method of claim 1 wherein the rule is one of a price rule, a volume rule, a gross margin rule, a size rule and a brand rule.

10. The method of claim 1 wherein the plurality of rule types are presented in a pull down menu.

11. The method of claim 1 wherein the at least one valid choice of for the attribute is presented in a pull down menu.
